(19) United States
(12) Patent Application Publication
(10) Pub. No.: US 2026/0093981 A1
(43) Pub. Date: Apr. 2, 2026

(54) METHODS AND SYSTEMS FOR CURATING HIGH-QUALITY DATA SAMPLES TO ENHANCE LARGE LANGUAGE MODEL PERFORMANCE

(71) Applicant: ACCENTURE GLOBAL SOLUTIONS LIMITED, Dublin 4 (IE)

(72) Inventors: Jinlong PANG, Mountain View, CA (US); Jiaheng Wei, Santa Clara, CA (US); Ankit Parag Shanh, Mountain View, CA (US); Yujia Bao, Cambridge, MA (US); Yaxuan Wang, Mountain View, CA (US); Wei Wei, Burlingame, CA (US); Yang Liu, Santa Cruz, CA (US); Chen Qian, Santa Cruz, CA (US); Zhaowei Zhu, San Jose, CA (US)

(73) Assignee: ACCENTRUE GLOBAL SOLUTIONS LIMITED, Dublin 4 (IE)

(21) Appl. No.: 19/346,080

(22) Filed: Sep. 30, 2025

Related U.S. Application Data
(60) Provisional application No. 63/701,954, filed on Oct. 1, 2024.

(51) Int. Cl. G06N 3/08; G06N 3/0475

(52) U.S. Cl. CPC G06N 3/08; G06N 3/0475

(57) ABSTRACT

Methods and systems for curating high-quality data samples to enhance Large Language Model (LLM) performance are disclosed. An input prompt corresponding to data samples of one or more datasets related to an enterprise is generated. Based on the input prompt, initial scores for the data samples are generated via implementation of one or more LLMs. Upon generating the input prompt, score curation is performed to correct score errors and to generate curated scores for the data samples. Further, diversity of the data samples is measured to generate long-tail scores for the data samples. The curated scores and the long-tail scores are utilized to determine the high-quality data samples from the data samples. The high-quality data samples are implemented to fine-tune a target LLM.

### CROSS-REFERENCE TO RELATED PATENT APPLICATIONS

This application claims priority to U.S. Provisional Application No. 63/701,954, filed on Oct. 1, 2024, the entire content of which is hereby incorporated by reference in the entirety for all purposes.

### TECHNICAL FIELD

Various examples described herein relate generally to methods and systems for curating high-quality data samples to enhance Large Language Model (LLM) performance.

### BACKGROUND

In the field of Artificial Intelligence (AI), Generative AI (GAI) has recently seen an explosion in popularity. The increasing power and popularity of GAI has seen enterprises seeking avenues to leverage GAI to improve enterprise operations. GAI includes Large Language Models (LLMs), which may be used to interact with multiple applications of the enterprises and provide input and/or data for execution of the various tasks or processes. Further, the LLMs may have capability of performing Natural Language Processing (NLP) related tasks and processing unstructured data. Due to such capability, the LLMs may be implemented for various domains and applications such as software engineering, computational biology, healthcare or medicine, and/or the like.

In order to implement the LLMs for the various domains and applications, the LLMs may be fine-tuned or aligned with user expectations, ensuring that responses generated using the LLMs align with user values and preferences. As most of the knowledge in the LLMs is acquired during pre-training, a subset of datasets curated through a set of datasets as a training dataset may suffice for effective alignment of each of the LLMs with the user expectations. Therefore, data selection systems may be employed to curate the training dataset for the LLMs. However, some of the data selection systems may rely on expensive and inconsistent human annotations or expensive models, or simplistic metrics or specific biased factors for curating the training dataset. Therefore, the curated training dataset may result in inefficient, inaccurate, redundant, and low-quality datasets, which may further degrade performance of the LLM and lead to sub-optimal results.

### SUMMARY

In an aspect, the present disclosure relates to a method for curating high-quality data samples to enhance Large Language Model (LLM) performance. The method includes generating an input prompt corresponding to data samples of one or more datasets related to an enterprise. Based on the input prompt, the method includes generating initial scores for the data samples via implementation of one or more LLMs. The method includes performing score curation to correct score errors and to generate curated scores for the data samples. The method includes measuring diversity of the data samples to generate long-tail scores for the data samples. The method includes utilizing the curated scores and the long-tail scores to determine the high-quality data samples from the data samples. The method includes implementing the high-quality data samples to fine-tune a target LLM, including training the target LLM using the high-quality data samples and updating, based on the training, at least one aspect of the target LLM.

In another aspect, the present disclosure relates to a system including a processor, and a memory communicatively coupled to the processor, wherein the memory includes processor-executable instructions, which on execution, cause the processor to: generate an input prompt corresponding to data samples of one or more datasets related to an enterprise; generate, based on the input prompt, initial scores for the data samples via implementation of one or more Large Language Models (LLMs); perform score curation to correct score errors and to generate curated scores for the data samples; measure diversity of the data samples to generate long-tail scores for the data samples; utilize the curated scores and the long-tail scores to determine high-quality data samples from the data samples; and implement the high-quality data samples to fine-tune a target LLM.

In another aspect, the present disclosure relates to a non-transitory computer-readable medium including machine-executable instructions that may be executable by a processor to perform the method as discussed herein.

It is appreciated that method in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features of the present disclosure will be apparent from the description and drawings, and from the claims.

### BRIEF DESCRIPTION OF THE FIGURES

Various implementations in accordance with the present disclosure will be described with reference to the drawings, in which:

FIG. 1 depicts an exemplary environment used to execute implementations of the present disclosure.

FIG. 2 depicts an exemplary architecture of a data curator and trainer of a system disclosed in the exemplary environment of FIG. 1, for curating high-quality data samples to enhance Large Language Model (LLM) performance, in accordance with implementations of the present disclosure.

FIG. 3 depicts an exemplary process flow of curating the high-quality data samples, in accordance with implementations of the present disclosure.

FIG. 4A depicts an exemplary illustration including score transition matrices across different LLMs without score curation, in accordance with implementations of the present disclosure.

FIG. 4B depicts an exemplary illustration including score transition matrices across the different LLMs with score curation, in accordance with implementations of the present disclosure.

FIG. 5 depicts an exemplary illustration including high and long-tail scores of data samples, in accordance with implementations of the present disclosure.

FIG. 6 depicts an exemplary flow diagram that presents a method for curating the high-quality data samples to enhance LLM performance, in accordance with implementations of the present disclosure.

FIG. 7 depicts an exemplary computer system, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including but not necessarily limited to;” it specifically indicates open-ended inclusion or membership in the so-described combination, group, series, and the like.

The term “a” means “one or more” unless the context clearly indicates a single element.

“First,” “second,” and/or the like., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, and/or the like).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/act involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring examples.

The specification and drawings are to be regarded in an illustrative rather than a restrictive sense. It will, however, be evident that various modifications and changes may be made thereunto without departing from the broader spirit and scope of the disclosure as set forth in the claims.

Implementations of the present disclosure provide a diversity-aware score curation framework for curating high-quality data samples for fine-tuning of a target Large Language Model (LLM). The diversity-aware score curation framework may improve prompt-based LLM rating systems by employing automatic score curation, which utilizes a score transition matrix to refine initial scores generated by one or more of LLMs for data samples and to assess a quality of each data sample more accurately. Additionally, the diversity-aware score curation framework may enable generation of long-tail scores for the data samples, while enabling the target LLM to learn from a broader and more diverse data distribution, as the data samples may vary significantly from one another. Such a combined emphasis on both the quality and diversity of the data samples may efficiently rectify score errors associated with the initial scores and may enhance LLM-based scoring/rating efficiency, which may further lead to improvements in downstream task performance and consistently across the one or more of the LLMs used for generating the initial scores.

The diversity-aware score curation framework may employ the following steps for curating the high-quality data samples for fine-tuning of the target LLM:
(i) Prompt-based LLM rating: The one or more of the LLMs (e.g., different pre-trained LLMs) may be leveraged for generating the initial scores for the data samples.
(ii) Curated quality score generation: A score transition matrix and K-Nearest Neighbor (K-NN) clusterability condition may be used to perform score curation. The score curation may involve identifying score errors/rating errors associated with the initial scores generated by the one or more of the LLMs for the data samples and generating curated scores for the data samples. The score curation may consistently improve performance of the diversity-aware score curation framework across the LLMs used to generate the initial scores.
(iii) Long-tail diversity score generation: The diversity of each of the data samples may be evaluated to generate the long-tail scores for the data samples. The long-tail scores may be generated by measuring a distance between embeddings corresponding to the data samples and identifying the data samples that fall outside of same or common clusters, which tend to be more distinct.
(iv) Data selection: The high-quality data samples from the data samples may be selected by first sorting the data samples based on the curated scores and then by the long-tail scores. The proposed dual strategy-based data selection may aid in efficient and accurate selection of the diverse and high-quality data samples, while removing poor-quality outliers/data samples. By way of non-limiting examples, among 300 k data samples, only 10 k of data samples may be selected as the high-quality data samples for fine-tuning of the target LLM, thereby a 96.7% of data reduction may be achieved, and 3.3% of the data samples (e.g., 10 k data samples) may outperform the 300 k data samples. Moreover, even with 3.3% of the data samples, performance of the target LLM may be significantly improved.

Further, the proposed diversity-aware score curation framework may ensure that the small and high-quality data samples avoid performance drops caused by low-rated or redundant data, revising traditional scaling laws that suggest usage of more data samples for fine-tuning of the LLMs. The proposed diversity-aware score curation framework may not only improve data efficiency but may also provide a cost-effective alternative to large-scale datasets and human annotations. The score curation employed by the diversity-aware score curation framework may emphasize importance of evaluating the quality of the data samples over quantity and ensure mitigation of LLM biases, which may further lead to improved LLM alignment with user expectations and downstream performance.

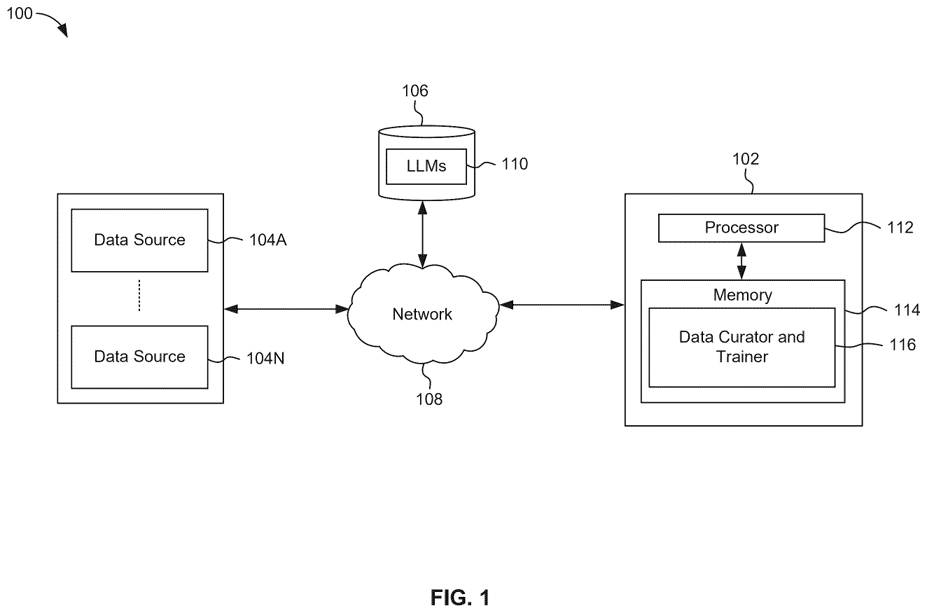

FIG. 1 depicts an exemplary environment 100 used to execute implementations of the present disclosure. The exemplary environment 100, depicted in FIG. 1, includes a system 102, data sources 104A-104N, and a model database 106. The system 102 may be communicatively coupled with the system 102, the data sources 104A-104N, and the model database 106 over a network 108. In some examples, the network 108 may include, but is not limited to, a Local Area Network (LAN), a Wide Area Network (WAN), the Internet, or a combination thereof. In some other examples, the network 108 may be accessed over a wired and/or a wireless communication link.

The data sources 104A-104N may include datasets of an enterprise. The datasets may be related to any of various domains or applications, for example, software development, healthcare, retail industries (including enterprise applications), industrial equipment, and/or the like. In some examples, the datasets may include datasets originated from human annotations. In some other examples, the datasets may include synthetic datasets generated using Generative Artificial Intelligence (GAI) models, for example, LLMs. Further, the datasets may vary in terms of a format, a quality, a prompt length, target tasks, and/or the like. Therefore, in the present disclosure, the datasets may exhibit varying degrees of diversity.

The model database 106 may include LLMs 110 (e.g., GAI models, foundation models, and/or the like). In an implementation, the LLMs 110 may include pre-trained LLMs. The pre-trained LLMs may be general-purpose GAI models like large deep learning neural networks, which may be trained using a broad range of training data (e.g., generalized and unlabeled data) to perform one or more tasks, such as, human computer interactions (e.g., question and answering), automating process execution, process planning, generating step-by-step procedures for process execution, performing data analysis, and/or the like. While implementations of the present disclosure are described in further detail herein with non-limiting reference to the LLMs 110, it is contemplated that implementations of the present disclosure may be realized using any appropriate foundation models or Machine Learning (ML) models, or Artificial Intelligence (AI) models.

The system 102 may curate high-quality data samples for enhancing LLM performance. In some examples, the system 102 may be implemented as an on-premises system that is operated by the enterprise or a third-party engaged in cross-platform interactions and data management. In some other examples, the system 102 may be implemented as an off-premises system (for example, cloud or on-demand) that is operated by the enterprise or a third-party on behalf of an enterprise.

In some other examples, the system 102 may be implemented in a cloud environment. For simplicity, the system 102 depicted in FIG. 1 may be a cloud environment that is intended to represent various forms of servers including a web server, an application server, a proxy server, a network server, a server pool, and/or the like.

In some examples, the system 102 may be implemented by way of a single device or a combination of multiple devices that may be operatively connected or networked together. The system 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, two or more lines of code, or other suitable software structures operating in one or more software applications.

Still referring to FIG. 1, the system 102 includes a processor 112 and a memory 114 communicably coupled to the processor 112. The processor 112 may include one or more processors. Examples of the processor 112 may include, but are not limited to, microprocessors, microcomputers, microcontrollers, digital signal processors, central processing units, state machines, logic circuits, and/or any devices that manipulate data or signals based on operational instructions. Among other capabilities, the processor 112 may fetch instructions (also be referenced to as processor-executable instructions or machine-executable instructions, executable, and/or the like) from the memory 114 and execute the fetched instructions for performing operations according to the present disclosure. The memory 114 may be non-volatile or non-transitory computer-readable medium (CRM) such as, a magnetic disk or solid-state non-volatile memory or volatile medium such as Random Access Memory (RAM), and/or the like. Further, the system 102 includes a data curator and trainer 116. The data curator and trainer 116 may be stored in the memory 114 and provided as a downloadable library including the instructions. The data curator and trainer 116 may act as a diversity-aware score curation framework for curating high-quality data samples to enhance LLM performance.

In an implementations, the processor 112 may execute a data curator and trainer 116 to curate the high-quality data samples and fine-tune a target LLM of the LLMs 110.

The data curator and trainer 116 may retrieve one or more datasets related to the enterprise from the data sources 104A-104N. Each of the datasets may include data samples. Upon retrieving the datasets, the data curator and trainer 116 may generate an input prompt corresponding to the data samples. Based on the input prompt, the data curator and trainer 116 may generate initial scores for the data samples using one or more of the LLMs 110. Once the initial scores are generated, the data curator and trainer 116 may perform score curation on the initial scores to correct score errors and to generate curated scores for the data samples. In addition to the curation scores, the data curator and trainer 116 may generate long-tail scores for the data samples by scoring diversity of each of the data samples. Utilizing the curated scores and the long-tail scores, the data curator and trainer 116 may determine the high-quality data samples from the data samples. Further, the data curator and trainer 116 may implement the high-quality data samples to fine-tune the target LLM of the LLMs 110. In an example, fine-tuning of the target LLM may include training the target LLM using the high-quality data samples and updating one or more aspects of the target LLM based on the training. Fine-tuning of the target LLM using the high-quality data samples may enhance performance of the target LLM and adapt the target LLM to down-stream tasks, while ensuring that responses generated using the fine-tuned LLM align with user expectations.

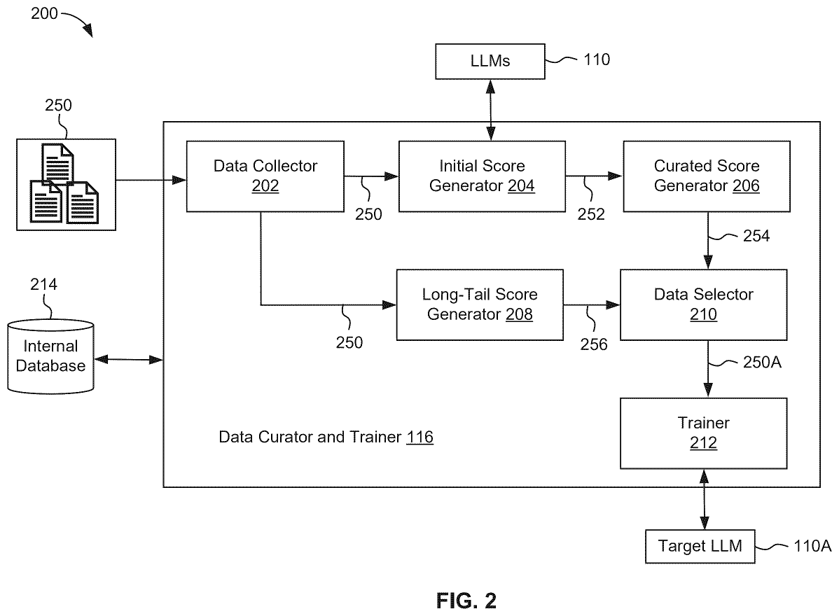

Various examples of curating the high-quality data samples for fine-tuning of the target LLM are described in detail in conjunction with FIGS. 2-7.

FIG. 2 depicts an exemplary architecture 200 of the data curator and trainer 116 of the system 102 disclosed in the exemplary environment 100 of FIG. 1, for curating high-quality data samples for fine-tuning of a target LLM 110A, in accordance with implementations of the present disclosure. As depicted in FIG. 2, the data curator and trainer 116 includes a data collector 202, an initial score generator 204, a curated score generator 206, a long-tail score generator 208, a data selector 210, and a trainer 212. In some examples, the data curator and trainer 116 may be communicatively coupled with an internal database 214, which may store various data and intermediate results generated by the data collector 202, the initial score generator 204, the curated score generator 206, the long-tail score generator 208, the data selector 210, and the trainer 212.

The data collector 202 may collect datasets related to the enterprise from the data sources 104A-104N (depicted in FIG. 1). Each of the datasets may include data samples 250. In some examples, the data samples 250 may include human-annotated data samples (e.g., sourced from human generated instructions). In some other examples, the data samples 250 may include synthetic data samples that are generated using GAI models or LLMs (e.g., sourced from LLM).

In an implementation, the data samples 250 may exhibit various degrees of diversity in terms of: a size, a format, a quality, a prompt length ‘L̅ₚᵣₒₘₚₜ’ (a length of a prompt), a response length ‘L̅ᵣₑₛₚₒₙₛₑ’ (a length of a response), a conversation turns ‘N̅_{rounds}’ (number of conversation turns that have been taken to generate the response), target tasks, and/or the like. By way of non-limiting example, exemplary details of the datasets including the data samples 250 are depicted in the table below:

TABLE 1
Details of Data Samples

| Datasets | Source | Size | Quality | N̅_{rounds} | L̅ₚᵣₒₘₚₜ | L̅ᵣₑₛₚₒₙₛₑ |
|---|---|---|---|---|---|---|
| Dataset-A | Human | 100K | Normal | 1.0 | 304.1 | 27.7 |
| | Annotated | | | | | |
| Dataset-B | Human | 33K | Both | 1.6 | 32.3 | 189.1 |
| | Annotated | | (Normal | | | |
| | | | and High) | | | |
| Dataset-C | Synthetic | 100K | High | 1.0 | 122.3 | 352.5 |
| Dataset-D | Human | 15K | Normal | 1.0 | 99.5 | 79.3 |
| | Annotated | | | | | |
| Dataset-E | Synthetic | 52K | Normal | 1.0 | 23.5 | 56.4 |

In some examples, the data collector 202 may standardize the format of the data samples 250 using a suitable template format. By way of non-limiting example, the template format may include “TULU” template format. The “TULU” template format may refer to standardized structure including two main tags and fields such as an instruction, an input, and a response. Therefore, the data samples 250 standardized using the “TULU” template format may include the instruction, the input, and the response. The instruction may indicate one or more tasks defined for one or more of the LLMs 110. The input may indicate content or input data to be processed by one or more of the LLMs 110. The response may indicate an output generated by one or more of the LLMs 110 after processing the input. The main tags of the “TULU” template format may include “User” and “Assistant”, which may reflect respective roles of a user and an assistant. The user may be an individual or an entity, who inputted the input for processing. The assistant may be a chatbot or an interface employed to provide the response to the user after processing the input using one or more of the LLMs 110. For example, the data sample may include:
“User”: Pick any color from the rainbow (the input)
“Assistant”: Purple (the response)

The data collector 202 may store the datasets including the data samples 250 in the internal database 214 or may provide the datasets including the data samples 250 to the initial score generator 204.

The initial score generator 204 may generate initial scores 252 for the data samples 250 using one or more of the LLMs 110. The initial scores 252 may refer to LLM rated scores for the data samples 250.

For generating the initial scores 252, the initial score generator 204 may generate an input prompt corresponding to the data samples 250. In some examples, the input prompt may be generated using prompt templates associated with one or more of the LLMs 110. The input prompt may enable the one or more of the LLMs 110 to generate an overall rating score (e.g., an overall rating, an integral evaluation score, and/or the like) by rating the corresponding data sample with respect to each of criteria such as, but are not limited to, relevance, complexity, clarity, rarity, informativeness, and/or the like.

In an example, the input prompt generated for an LLM of the LLMs 110 may include a system prompt, a user prompt, and the corresponding data sample (including the instruction, the input, and the response). The system prompt may indicate a task to be performed for the LLM. In an example herein, the system prompt may indicate the LLM to rate the data sample based on each of criteria such as, but are not limited to, relevance, complexity, clarity, rarity, informativeness, and/or the like, and provide the overall rating score. The user prompt may indicate the LLM to process the corresponding data sample and a pre-defined format to provide the overall rating score.

For example, the pre-defined format may include a structured or semi-structured format like JavaScript Object Notation (JSON) format. An exemplary input prompt generated for the LLM in order to generate the overall rating score for the data sample include:
“<System Prompt>: As a data quality estimator, your task is to assess the quality of the data sample based on the criteria: Rarity, Complexity, and Informativeness. Please rate the sample on a scale from 1 to 10 for each criterion, and return an overall rating on a scale of ‘1’ to ‘10’, where a higher score indicates a higher level of quality. Ensure that the ratings are not overly concentrated around a specific score. If multiple samples have similar qualities, consider spreading the scores more evenly to reflect subtle differences.
<User Prompt>: Please carefully evaluate the following data sample and return the integral evaluation scores using the JSON format:

{″Rarity″: <number, 1-10>,
″Complexity″: <number, 1-10>,
″Informativeness″: <number, 1-10>,
″Overall rating″: <number, 1-10>}
Instruction: [Instruction]
Input: [Input]
Response: [Response]”

Upon generating the input prompt corresponding to the data samples 250, the initial score generator 204 may provide the input prompt and the corresponding data samples 250 to the one or more of the LLMs 110 and receive the overall rating scores for the corresponding data samples 250 from the one or more of the LLMs 110. The overall rating scores may capture subtle differences between the data samples 250. The overall rating score may be generated by rating the corresponding data sample according to a pre-determined scale. By way of non-limiting example, the pre-determined scale may include a continuous integer scale from ‘1’ to ‘10’ (e.g., {1, 2, . . . , 10}), wherein ‘1’ may represent the lowest rating and ‘10’ may represent the highest rating. The lowest rating may indicate that the corresponding data sample is of low quality, and the highest rating may indicate that the corresponding data sample is of high quality. Therefore, the overall rating scores may include low scores and high scores. To simplify such a score distribution, the initial score generator 204 may merge the overall rating scores including the low scores in {1, 2, 3, 4} and the overall rating scores including the high scores in {9, 10}, thereby resulting in a new scale of {4, 5, . . . , 9}. Further, the initial score generator 204 may scale down the new scale of {4, 5, . . . , 9} to {0, 1, 2, . . . , 5}, which may constitute the initial scores 252 for the data samples 250.

The initial scores 252 may vary on a scale of ‘0’ to ‘5’. The initial scores 252 may be used to determine high-rated data samples among the data samples 250. The high-rated data samples may include data samples with the higher initial scores compared to other data samples of the data samples 250. The initial scores 252 in the present disclosure may be generated primarily based on the overall rating scores including the high scores. In addition, starting with a large scale (e.g., {1, 2, . . . , 10}) and then narrowing the scale (e.g., {1, 2, . . . , 5}) may enable the target LLM 110A to distinguish subtle quality differences in mid-rated samples better, while improving performance of the target LLM 110A. An exemplary low-rated data sample (e.g., a data sample with low initial score) and an exemplary high-rated data sample are depicted in the table below:

TABLE 2
Exemplary low-rated and high-rated data samples

| Low-Rated Data Sample | High-Rated Data Sample |
|---|---|
| <\|User\|>: Instruction: Given a set of numbers, | <\|User\|>: Instruction: Create a list of best |
| find the maximum value. | practices that should be followed in this field. |
| Input: Set: {10, 3, 25, 6, 16} | Field: Healthcare information technology. |
| <\|Assistant\|>: | <\|Response\|>: The following best practices |
| Response: The maximum value is 25. | should be followed in the healthcare |
| | information technology field: |
| | 1. Adopt a risk-based approach to |
| | cybersecurity, utilizing measures such as |
| | multi-factor authentication, encryption, and |
| | vulnerability assessments. |
| | 2. Develop clear guidelines and policies |
| | governing the use of technology. |
| | 3. Develop protocols to ensure the secure |
| | sharing of patient data. |
| | 4. Implement robust data processing and |
| | storage systems that adhere to industry |
| | regulations. |
| | 5. Train healthcare staff in both the technical |
| | and non-technical aspects of IT use. |
| | 6. Utilize professional IT staff for any |
| | maintenance or development tasks. |
| | 7. Regularly test and monitor IT systems for |
| | potential vulnerabilities. |

The initial score generator 204 may provide the initial scores 252 of the data samples 250 to the curated score generator 206 and/or may store the initial scores 252 in the internal database 214.

The curated score generator 206 may perform score curation to correct score errors associated with the initial scores 252 and accordingly to generate curated scores 254 (e.g., candidate scores) for the data samples 250.

For performing the score curation, the curated score generator 206 may receive the data samples 250 and generate embeddings (e.g., vector embeddings, embedding vectors, embedding features, feature vectors, and/or the like) corresponding to the data samples 250. The embeddings may include numerical representations of the respective data samples 250. In some examples, the curated score generator 206 may use an embedding model (not shown) for generating the embeddings for the data samples 250.

After generating the embeddings, the curated score generator 206 may implement K-Nearest Neighbor (KNN) clustering to determine/derive a score transition matrix. The score transition matrix may be used to identify the score errors associated with the initial scores 252 and to correct the score errors associated with the initial scores 252.

To illustrate in detail, consider an example wherein one or more of the datasets include ‘N’ data samples (e.g., the data samples 250). A dataset ‘D’ including the ‘N’ data samples may be represented as:

$$D : = {\{ {x}_{n} , {\tilde{y}}_{n} \}}_{n = 1}^{N}$$

wherein, ‘x’ may represent an embedding corresponding to the data sample (including the instruction, the input, and the response) and ‘\tilde{y}’ may represent the initial score generated by the LLM of the LLMs 110 for the corresponding data sample. In an implementation, the curated score generator 206 may consider that a ground-truth score ‘y’ (e.g., an unobserved ground-truth score) and the initial score ‘\tilde{y}’ are in a same discretized K-class classification or embedding space ‘Y’ to derive the score transition matrix, wherein K=6 as the initial score varies from ‘0’ to ‘5’. The score transition matrix derived from the K-NN clustering may be used to identify the score errors. The score transition matrix ‘T(x)’ may be defined as a ‘K×K’ square matrix, wherein ‘x’ may represent the embedding. Further, each entry ‘T_{i,j}(x)’ may represent a probability of transitioning from a ground-truth score ‘i’ to the initial score ‘j’ (generated for the data sample using the one or more of the LLMs 110). For example, each entry ‘T_{i,j}(x)’ of the score transition matrix may be represented as:

$${T}_{i , j} ( x ) = ℙ ( \tilde{y} = j \vert y = i , x ) , {∀}_{i , j} ∈ [ K ]$$

In an implementation, the score transition matrix may be considered as independent of sample-level features (e.g., ‘x’) that is T(x)=T. When the initial scores 252 match with corresponding ground-truth scores (e.g., ground-truth quality scores) that is \tilde{y}ₙ=yₙ, ∀ₙ, then the score transition matrix may be equivalent to an identity matrix (e.g., T(x)=I). In such a scenario, the curated score generator 206 may determine zero score errors. Therefore, the closer the score transition matrix is to the identity matrix, the score errors associated with the initial scores 252 may be minimal. As the ground-truth scores may not be accessed directly to determine the score transition matrix, the initial scores 252 generated for the data samples 250 may be used to determine the score transition matrix using K-NN score clusterability condition. The K-NN score clusterability condition may indicate that similar embeddings corresponding to the data samples 250 are required to belong to the same cluster (e.g., category or ground-truth class or K-NN cluster). For example, the dataset ‘D’ including the ‘N’ data samples may satisfy the K-NN score clusterability condition if ‘∀ₙ’, the embedding ‘xₙ’ and its K-NNs: “xₙ_{₁}, . . . , xₙ_{ₖ}” may belong to the same cluster. In an implementation, the K-NN score clusterability condition may include 2-NN clusterability that is the similar embeddings corresponding to the data samples 250 are required to belong to a 2-NN cluster.

In order to determine/derive the score transition matrix, the curated score generator 206 may define a ground-truth score probability distribution ‘p’ and the score transition matrix for a K-class classification problem. The K-class classification problem may refer to a supervised learning task, where the embeddings of the data samples 250 may be assigned to one of K-distinct categories/clusters. The ground-truth score probability distribution and the score transition matrix for the K-class classification problem may be defined as:

$$Ground - score probability distribution p := {[ ℙ ( y = i ) , i ∈ [ K ] ]}^{T}$$

$$Score transition matrix {T}_{s} := T \cdot {A}_{s} , {∀}_{s} ∈ [ K ]$$

wherein, ‘Aₛ’ may be a cyclic permutation matrix, which may be represented as:

$${A}_{s} : = [ {e}_{S + 1} , {e}_{S + 2} , {e}_{K} , {e}_{1} , {e}_{2} , … {e}_{s} ]$$

wherein, ‘eₛ’ may be a ‘K×1’ column vector with ‘1’ at the s-th position and ‘0’ elsewhere. The cyclic permutation matrix may cyclically shift each column of ‘T’ to its left side by ‘s’ units. Further, the curated score generator 206 may define an index after performing the cyclic shift within the range of ‘K’. In an example, the index ‘(i+s)_{K}’ may be defined as:

$${( i + s )}_{K} : = [ ( i + s - 1 ) mod K ] + 1$$

Upon performing the cyclic shift, the curated score generator 206 may employ consensus vectors to measure an agreement between the initial score of the embedding corresponding to the data sample and initial scores of neighboring embeddings corresponding to neighboring data samples (e.g., K-NNs) of the data sample. It should be noted that the data sample and the neighboring data samples may constitute the data samples 250. For example, if the embedding/data sample has three neighboring embeddings/data samples and initial scores of the neighboring embeddings/data samples include \tilde{y}₁, \tilde{y}₂, and \tilde{y}₃, respectively, then curated score generator 206 may define the consensus vectors as:

$${v}^{[ 1 ]} : = {[ ℙ ( {\tilde{y}}_{1} = i ) , i ∈ [ K ] ]}^{T} = {T}^{T} p$$

$${v}_{l}^{[ 2 ]} : = {[ ℙ ( {\tilde{y}}_{1} = i , {\tilde{y}}_{2} = {( i + l )}_{K} ) , i ∈ [ K ] ]}^{T} = {( T ∘ {T}_{l} )}^{T} p$$

$${v}_{i , s}^{[ 3 ]} : = {[ ℙ ( {\tilde{y}}_{1} = i , {\tilde{y}}_{2} = {( i + l )}_{K} ) , ( {\tilde{y}}_{3} = {( i + l )}_{K} ) i ∈ [ K ] ]}^{T} = {( T ∘ {T}_{l} ∘ {T}_{s} )}^{T} p$$

wherein, ‘∘’ may represent a Hadamard product. The above-defined consensus vectors may quantify how likely the neighboring embeddings may share the same initial scores and score probability information is directly encoded into the agreement between the initial score of the embedding/the data sample and the initial scores of neighboring embeddings/neighboring data samples.

For example, consider a scenario where a data sample has an initial score of ‘5’ with two nearest neighbors (2-NN), each having initial score of ‘2’. In such an example, the agreement between the initial scores of the 2-NN and disagreement between a high rating of ‘5’ and a low rating of ‘2’ may be controlled by certain probabilities, for example, the score transition matrix ‘T’ and the ground-truth score probability distribution ‘p’, as depicted in the above-described consensus vectors. To solve the above-described consensus vectors, the curated score generator 206 may utilize K-NN statistical information. Solving the above-described consensus vectors may result in estimation of numerical values of the consensus vectors. The K-NN statistical information may indicate different agreement patterns between the data samples 250. Once the consensus vectors are solved, the curated score generator 206 may reformulate the estimated numerical values of the consensus vectors as a classical linear programming problem with unknown variables, the score transition matrix ‘T’ and the ground-truth score probability distribution ‘p’. Further, the curated score generator 206 may solve the classical linear programming problem in a third-order consensus vectors setting to derive the score transition matrix ‘T’ and the ground-truth score probability distribution ‘p’, which is described in detail below.

For the data sample having the initial score of ‘5’ with two nearest neighbors (2-NN), each having initial score of ‘2’, the curated score generator 206 may consider a binary scenario that is K=2 with two types of scores {0, 1} and define the ground-truth score and the probabilities of transitioning from the ground-truth score to the initial scores of the data sample and its two nearest neighbors (hereinafter referred to as transition probabilities/error rates). The transitional probabilities ‘e₀₁’ and ‘e₁₀’ may be as defined as:

$${e}_{01} : = T ( 0 , 1 ) = ℙ ( \tilde{y} = 1 \vert y = 0 )$$

$${e}_{10} : = T ( 1 , 0 ) := ℙ ( \tilde{y} = 0 \vert y = 1 )$$

wherein, ‘y’ may represent the ground-truth score and ‘\tilde{y}’ may represent a score error/observed noisy score.

Further, in accordance with the K-NN clusterability condition, for example herein, the 2-NN clusterability, the initial scores for the data sample and its two nearest neighbors (e.g., three data samples) within the 2-NN cluster have to be identical that is y₁=y₂=y₃=y. Exemplary data samples and nearest neighbors of each of the exemplary data samples are depicted in the table below:

TABLE 3
Example data sample and its nearest neighbors

| Data Sample | First Nearest Neighbor | Second Nearest Neighbor |
|---|---|---|
| User: Pick any color from the | User: Pick any color from the | User: Pick any color from the |
| rainbow. | rainbow. | rainbow. |
| Assistant: Purple | Assistant: Blue | Assistant: Red, orange, |
| Initial score: 1 | Initial score: 0 | yellow, green, blue, indigo, |
| | | and purple |
| | | Initial score: 1 |
| User: You need to complete | User: Calculate 50% of 300. | User: Calculate 15% of 500. |
| the following task: Calculate | Assistant: 50% of 300 is 150. | Assistant: 75 |
| 15% of the following | Initial score: 3 | Initial score: 3 |
| number: 100. | | |
| Assistant: 15% of 100 is 15. | | |
| Initial score: 1 | | |
| User: What is the | User: Write a response that | User: Convert this |
| hexadecimal representation of | completes the request. | hexadecimal value 0xAF to |
| the decimal number 74? | Convert the number 18 to | its equivalent decimal number |
| Assistant: 4A | hexadecimal. | Assistant: 175 |
| Initial score: 1 | Assistant: The hexadecimal | Initial score: 1 |
| | representation of 18 is 0x12. | |
| | Initial score: 0 | |

Further, a probability of the ground-truth score ‘pᵢ= [symbol] (y=i),∀ᵢ∈[K]’ may be unknown. Therefore, the curated score generator 206 may employ the higher-order consensus vectors among K-NN cluster's scores in order to estimate the transitional probabilities/error rates ‘e₀₁’ and ‘e₁₀’, which is described in detail below:

### (i) First-Order Consensus Vector:

$$ℙ ( {\tilde{y}}_{1} = k ) : = {\sum }_{i ∈ [ K ]} ℙ ( {\tilde{y}}_{1} = k \vert {y}_{1} = i ) , ∀ k ∈ [ K ]$$

Using the first-order consensus vector, the curated score generator 206 may obtain two first-order equations, such as:

$$ℙ ( {\tilde{y}}_{1} = 0 ) : = {p}_{0} ( 1 - {e}_{01} ) + ( 1 - {p}_{0} ) {e}_{10}$$

$$ℙ ( {\tilde{y}}_{1} = 1 ) : = ( 1 - {p}_{0} ) ( 1 - {e}_{01} ) + {p}_{0} {e}_{10}$$

### (ii) Second-Order Consensus Vector, Such as:

$$\begin{matrix}ℙ ( {\tilde{y}}_{1} = k , {\tilde{y}}_{2} = {k}^{′} ) {=}^{( a )} {\sum }_{i ∈ [ K ]} ℙ ( {\tilde{y}}_{1} = k , {\tilde{y}}_{2} = {k}^{′} ) \vert {y}_{1} = i , {y}_{2} = i ) ℙ ( {y}_{1} = i ) \\ {=}^{( b )} {\sum }_{i ∈ [ K ]} ℙ ( {\tilde{y}}_{1} = k \vert {y}_{1} = i ) ℙ ( {\tilde{y}}_{2} = {k}^{′} \vert {y}_{2} = i ) \\ ℙ ( {y}_{1} = i ) , ∀ k , {k}^{′} ∈ [ K ]\end{matrix}$$

wherein, equality (a) holds due to the 2-NN clusterability condition and quality (b) holds because of the conditional independence between ‘\tilde{y}₁’ and ‘\tilde{y}₂’ based on their ground-truth score. Using the second-order consensus vector, four second order equations may be derived as:

$$ℙ ( {\tilde{y}}_{1} = 0 , {\tilde{y}}_{2} = 0 ) : = {{p}_{0} ( 1 - {e}_{01} )}^{2} + ( 1 - {p}_{0} ) {e}_{10}^{2} ,$$

$$ℙ ( {\tilde{y}}_{1} = 1 , {\tilde{y}}_{2} = 1 ) : = ( 1 - {p}_{0} ) {( 1 - {e}_{01} )}^{2} + {p}_{0} {e}_{01}^{2}$$

(iii) Third-Order Consensus Vector, Such as:

$$ℙ ( {\tilde{y}}_{1} = K , {\tilde{y}}_{2} = {k}^{′} , {\tilde{y}}_{3} = {k}^{′′} ) : = {\sum }_{i ∈ [ K \}} ℙ ( {\tilde{y}}_{1} = k , {\tilde{y}}_{2} = {k}^{′} , {\tilde{y}}_{3} = {k}^{′′} \vert {y}_{1} = i , {y}_{2} = i , {y}_{3} = i ) ℙ ( {y}_{1} = i )$$

Using the third-order consensus vector that is from different combinations of ‘\tilde{y}₁’, ‘\tilde{y}₂’, and ‘\tilde{y}₃’ eight third-order equations may be derived as:

$$ℙ ( {\tilde{y}}_{1} = 1 , {\tilde{y}}_{2} = 2 , {\tilde{y}}_{3} = 1 ) : = ( 1 - {p}_{0} ) {( 1 - {e}_{10} )}^{3} + {p}_{0} {e}_{01}^{3}$$

The above-described consensus vectors may rely on the average probabilities across all the 2-NN clusters. As such, thereby potential score errors or score noise from low-quality data samples among the data samples 250 may be mitigated, which may further adapt the system 102 to tolerate any K-NN violations.

The curated score generator 206 may use the above-described equations to derive the ground-truth score probability ‘po’ and the transition probabilities/error rates ‘e₀₁’ and ‘e₁₀’. The curated score generator 206 may determine/derive the score transition matrix ‘T’ based on the transition probabilities/error rates ‘e₀₁’ and ‘e₁₀’. Further, the curated score generator 206 may summarize the ground-truth score probability information across all the 2-NN clusters to derive the score transition matrix.

Once the score transition matrix is derived/determined, the curated score generator 206 may use the score transition matrix to identify the score errors associated with the initial scores 252 generated by the one or more of the LLMs 110 for the data samples 250. Upon identifying the score errors, the curated score generator 206 may correct such score errors by generating the curated scores 254.

To illustrate in detail, the score transition matrix may characterize the transition probabilities of the score errors. However, the score transition matrix may operate at the dataset level and accordingly the score transition matrix may not be used in correcting the score errors. Therefore, the curated score generator 206 may perform the score curation to correct the score errors by evaluating and ranking the data samples 250 based on the agreement of the initial scores 252 among the K-NN samples of each data sample. In an example, the curated score generator 206 may use a cosine similarity measure/cosine similarity metric for evaluating and ranking the data samples 250. By way of non-limiting example, the data sample may be evaluated using the cosine similarity measure as:

$$Similarity score ( {v}_{1} , {v}_{2} ) = \frac{{v}_{1}^{T} {v}_{2}}{{‖ {v}_{1} ‖}_{2} {‖ {v}_{2} ‖}_{2}}$$

wherein, ‘v₁’ and ‘v₂’ may represent generic vectors. The generic vectors may include the embeddings ‘xₙ’ of the data sample or one-hot encoding rated score vector ‘\tilde{y}ₙ’. The one-hot encoding rated score vector may include a one-hot encoding of the initial score ‘\tilde{y}ₙ’ generated by the LLM for the data sample. In an example, the curated score generator 206 may use the one-hot encoding rated score vector and a soft K-NN score of the ‘n-th’ data sample

$$‘ {\tilde{y}}_{n}^{K - N N} ’$$

for computing the agreement of the initial scores 252 among the K-NN samples of each data sample. The soft K-NN score of the ‘n-th’ data sample may be calculated by counting the agreement among the K-neighbor examples when the K-NN clusterability condition holds or satisfies for the data samples 250 of the dataset. The computed agreement of the initial scores 252 among the K-NN samples of each data sample may be used for evaluation and ranking of the data samples 250. Such evaluation and ranking may aid in identifying correct initial scores. Specifically, the initial score with the highest cosine similarity across different scoring options may aid in efficient identification of the correct initial scores.

In an implementation, evaluating and ranking the data samples 250 based on the agreement of the initial scores 252 among the K-NN samples of each data sample may involve analyzing distribution of average score gaps. An average score gap may measure a score difference within one of the K-NN clusters. An average score gap for the data sample may be defined as a mean absolute difference between the initial score of the data sample and the initial scores of its K-NN data samples. For example, the average score gap may be defined as:

$$Average score gap = Mean ( \vert initial score of data sample - K - NN sample ’ s \vert inital score$$

By way of non-limiting example, a 2-NN cluster with a score tuple as: <data sample: 1, K-NN sample-1 (e.g., first nearest neighbor): 2, and K-NN sample-2 (e.g., second nearest neighbor): 3>may be implemented. In such an example, the average score gap may be measured as 1.5. The average score gap may be used to ranking the data samples 250.

Upon evaluating and ranking the data samples 250, the curated score generator 206 may apply the score transition matrix on the data samples 250 (e.g., previously evaluated and ranked) to establish or determine an error threshold, while identifying a subset of the data samples 250 that requires correction. The error threshold may be used to identify the score errors associated with the initial scores 252 of the data samples 250 and correct the score errors with the curated scores 254 for the given agreement of the initial scores 252 among the K-NN samples of each data sample. In an example, the error threshold may be determined using Bayesian rule with the score transition matrix and the ground-truth score distribution. By way of non-limiting example, the error threshold may be identified as:

$$Error Threshold : {\tilde{N}}_{i} \approx {N}_{i} \times ℙ ( y \neq i \vert \tilde{y} = i ) = {N}_{i} \times ( 1 - \frac{ℙ ( \tilde{y} = i \vert y = i ) \cdot ℙ ( y = i )}{ℙ ( \tilde{y} = i )}$$

wherein, ‘Nᵢ’ may be a sample size for i-th rated score, ‘ [symbol] (z≠i|\tilde{y}=i)’ may be a score transition probability from the score transition matrix and ‘ [symbol] (y=i)’ may represent the ground-truth score probability from ‘p’. An initial score probability ‘ [symbol] (\tilde{y}=i)’ may be estimated by counting the frequency of the initial scores 252. In an example, the lower cosine similarity score may indicate a higher likelihood of the score error. Therefore, the lowest-ranking ‘Ñᵢ’ samples may be considered mis-rated data samples and corrected using the curated scores 254 depending on the K-NN agreement, specifically those with the highest cosine similarity among the different rating options.

In addition, the curated score generator 206 may enhance the score curation by employing a mechanism to mitigate imbalances in a distribution of the initial scores 252, which may further ensure more accurate corrections and improved overall performance. In an example, leveraging the K-NN statistical information for performing the score curation may result in an issue where multiple high-rated samples are downgraded toward a majority-rated score, for example, ‘3’. Such unintended effect may result in performance degradation, as a significant number of high-rated samples are incorrectly lowered.

For mitigating the imbalances, the curated score generator 206 may employ a confidence probability to regulate a size of the mis-rated data samples. In an example, the confidence probability may be defined as:

$$𝒫 ( {\hat{y}}_{n} = j ) : = \overline{ℙ} ( {\hat{y}}_{n} = j ) \times {\overline{p}}_{n}$$

wherein, ‘ŷₙ’ may represent the curated score of the data sample ‘n’, ‘ [symbol] (ŷₙ=j)’ may represent an average probability of assigning the data sample ‘n’ to the j-th score, and ‘p̅ₙ’ may represent an average likelihood of identifying the data sample ‘n’ as mis-rated over multiple epochs. By way of non-limiting example, the default confidence probability may be ‘0.5’. By employing the confidence probability, the curated score generator 206 may enhance the score curation for threshold-based deviation of the mis-rated data samples, thereby mitigating negative effects caused by imbalances of the distribution of the initial scores 252. Exemplary data samples and associated initial and curated scores are depicted in the table below:

TABLE 4
Exemplary data samples and associated initial and curated scores

| | Initial | Curated |
|---|---|---|
| Data Sample | Score | Score |
| <User>: Based on the premise “i think it would too”, can we | 5 | 1 |
| conclude the hypothesis “I also think it would.” is true (see | | |
| options)? Pick from: (i) yes; (ii) it is not possible to tell; (iii) no; | | |
| <Assistant>: (i) | | |
| <User>: Premise: Island society has seen more change in the last | 5 | 0 |
| twenty years than in the previous thousand. Hypothesis: Island | | |
| society has been changing rapidly because of boats with | | |
| powerful motors. Is the hypothesis entailed by the premise? | | |
| Select from: 1. yes. 2. It is not possible to tell. 3. no. And the | | |
| answer is: | | |
| <Assistant>: 2. | | |
| <User>: Ask a question about Queen V. | 5 | 2 |
| <Assistant>: Who did Queen V dislike so much she banned him | | |
| from her presence once she became Queen? | | |

The curated score generator 206 may store the curated scores 254 in the internal database 214 and/or may provide the curated scores 254 to the data selector 210.

The long-tail score generator 208 may generate long-tail scores 256 (also referred to as “diversity-aware long-tail scores”) for the data samples 250A based on evaluation of the diversity of the data samples 250. The long-tail scores 256 may reflect distribution of the data samples rather than the initial scores 252 generated for the data samples 250 using the one or more of the LLMs 110. Therefore, the long-tail scores may be independent of the initial scores 252 of the data samples 250.

For generating the long-tail scores 256, the long-tail score generator 208 may utilize the embeddings of the data samples 250. Specifically, the long-tail score generator 208 may compute an average cosine similarity between the embedding of the data sample and embeddings of its nearest neighbors. The average cosine similarity may act as a long-tail score of the corresponding data sample. For example, the highest long-tail score may indicate greater diversity among the data samples 250. The long-tail score generator 208 may store the long-tail scores 256 in the internal database 214 and/or may provide the long-tail scores 256 to the data selector 210.

The data selector 210 may select high-quality data samples 250A from the data samples 250 for fine-tuning of the target LLM 110A. The target LLM 110A may be one of the LLMs 110. The high-quality data samples 250A may include a subset of the data samples 250. The high-quality data samples 250A may include high-quality, diverse, and representative data samples. In addition, the high-quality data samples 250A may exhibit high signal-to-noise ratio, semantic relevance, and structural consistency. The high-quality data samples 250A may be selected based on the curated scores 254 and the long-tail scores 256. Specifically, the high-quality data samples 250A may be selected by first sorting the data samples 250 based on the curated scores 254 and then by the long-tail scores 256. The data selector 210 may provide the high-quality data samples 250A to the trainer 212 and/or may store the high-quality data samples 250A in the internal database 214.

The trainer 212 may implement the high-quality data samples 250A to fine-tune the target LLM 110A. Fine-tuning of the target LLM may include training of the target LLM 110A using the high-quality data samples 250A and updating, based on the training, at least one aspect of the target LLM 110A. Non-limiting examples of the at least aspect of the target LLM 110 may include layer parameters, attention weights, feed forward layer parameters, layer normalization layer parameters, output head parameters, a number of epochs, a training batch size, a learning rate, weight decay, optimizer, loss function and/or the like. The (fine-tuned) target LLM 110A may be employed by the enterprise to efficiently perform various tasks/operations related to the specific domains or applications.

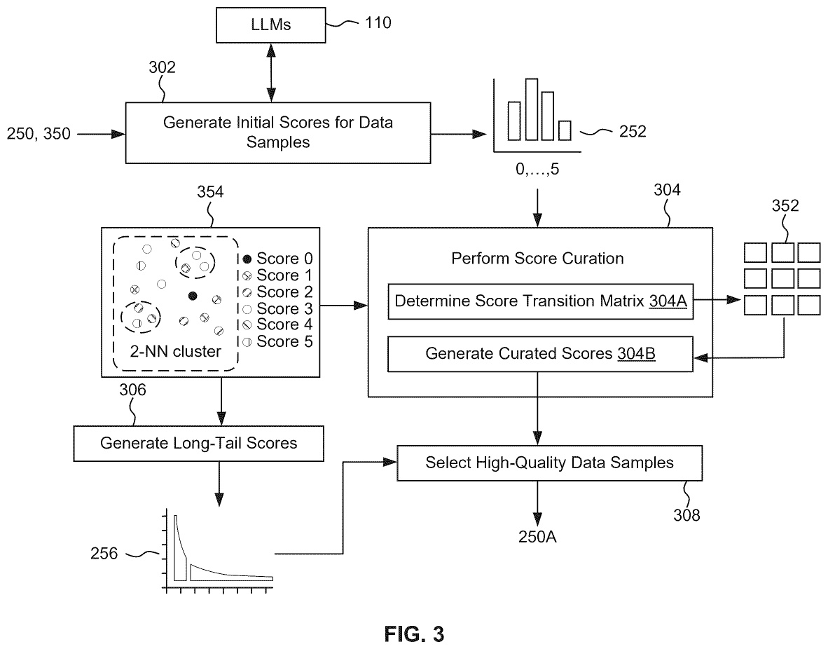

FIG. 3 depicts an exemplary process flow 300 of curating the high-quality data samples 250A for fine-tuning of the target LLM 110A, in accordance with implementations of the present disclosure. In an example, the process flow 300 may be executed using the data curator and trainer 116, as described in relation to FIGS. 1-2.

At step 302, the data curator and trainer 116 may generate the initial scores 252 for the data samples 250 using the one or more of the LLMs 110. The data curator and trainer 116 may provide the data samples 250 and an input prompt 350 corresponding to the data samples 250 to the one or more of the LLMs 110 (e.g., pre-trained LLMs) and receive the initial scores 252 for the data samples 250 from the one or more of the LLMs 110.

At step 304, the data curator and trainer 116 may perform the score curation. The score curation may involve determining, at step 304A, a score transition matrix 352 based on the K-NN statistical information 354 (without relying on ground-truth scores) and generating, at step 304B, the curated scores 254 for the data samples 250 by identifying and rectifying the score errors associated with the initial scores 252 using the score transition matrix 352.

Specifically, performing the score curation may include verifying the agreement of the initial scores 252 of the data samples 250 based on the K-NN clustering, identifying the data samples with a (e.g., lesser) agreement score according to the error threshold, employing the confidence probability to regulate the mis-rated data samples for addressing score imbalance problem, and assigning the majority of the K-NN agreement scores as the curated scores 254 for the mis-rated data samples. The data samples with the (e.g., lesser) agreement score may indicate the mis-rated data samples.

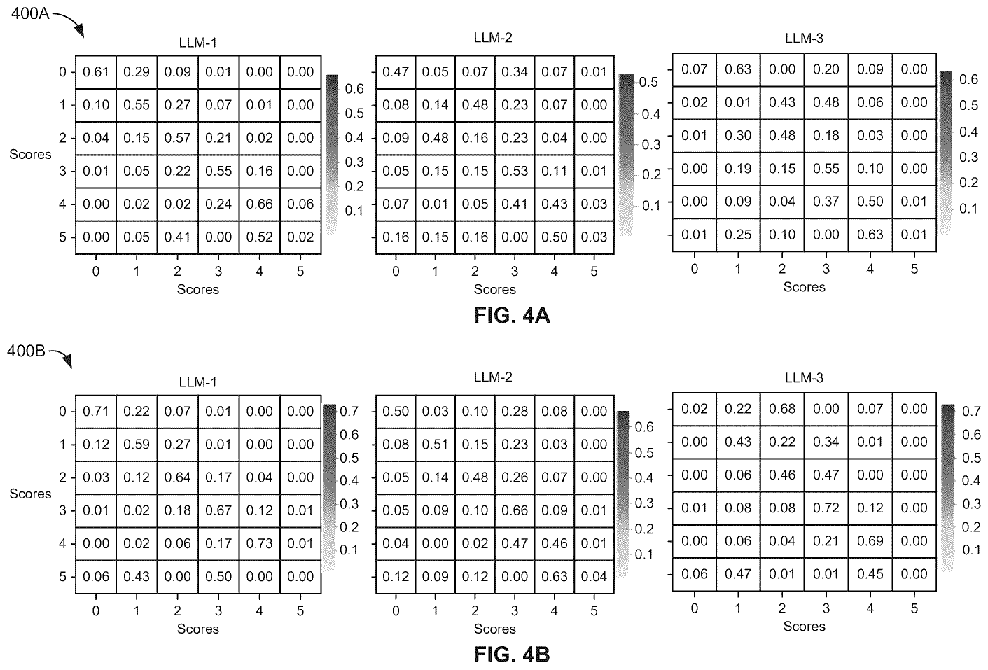

An exemplary illustration 400A including score transition matrices across different LLMs (used to generate the initial scores for the data samples 250) without score curation is depicted in FIG. 4A. As depicted in FIG. 4A, the different LLMs may include an LLM-1, an LLM-2, and an LLM-3 of the LLMs 110. Further, using the score transition matrices across the LLM-1, the LLM-2, and the LLM-3, it may be determined that the initial scores 252 generated using the LLM-2 and the LLM-3 may exhibit more score errors compared to the initial scores 252 generated using the LLM-1. Specifically, the score errors corresponding to the LLM-1 may occur between adjacent values, which may reflect rating/scoring stability of the LLM-1. In contrast to the LLM-1, the LLM-2 and the LLM-3 may exhibit more variations in its initial scores, which may reflect their failed capability to measure data quality consistently. An exemplary illustration 400B including score transition matrices across the different LLMs (used to generate the initial scores for the data samples 250) with score curation is depicted in FIG. 4B. As depicted in FIG. 4B, the different LLMs may include the LLM-1, the LLM-2, and the LLM-3 of the LLMs 110. By comparing the score transition matrices of FIG. 4B with the score transition matrices of FIG. 4A, it may be evident that the score curation may significantly reduce the probability of incorrect score transitions in the matrices.

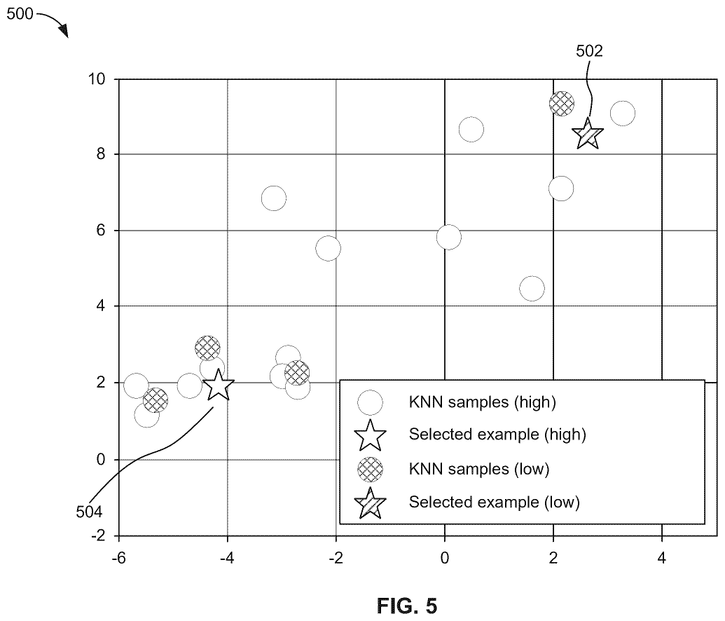

At step 306, the data curator and trainer 116 may generate the long-tail scores 256 based on the K-NN statistical information for rare-data selection. The long-tail scores 256 may be generated by evaluating and rating/measuring the diversity of the data samples 250. An exemplary illustration 500 including high and long-tail scores is depicted in FIG. 5. As depicted in FIG. 5, a data sample 502 may be assigned with the high long-tail score that may reflect a high diversity of the data sample 502, where corresponding K-NNs are far away from the data samples 502. Alternatively, a data sample 504 is assigned with the low long-tail score that may reflect a low diversity of the data sample 502, where corresponding K-NNs may be clustered closely around the data sample 504.

At step 308, the data curator and trainer 116 may select the high-quality data samples 250A among the data samples 250. The selection of the high-quality data samples 250A may rely on the curated scores 254 and the long-tail scores 256 to prioritize data quality while maintaining diversity.

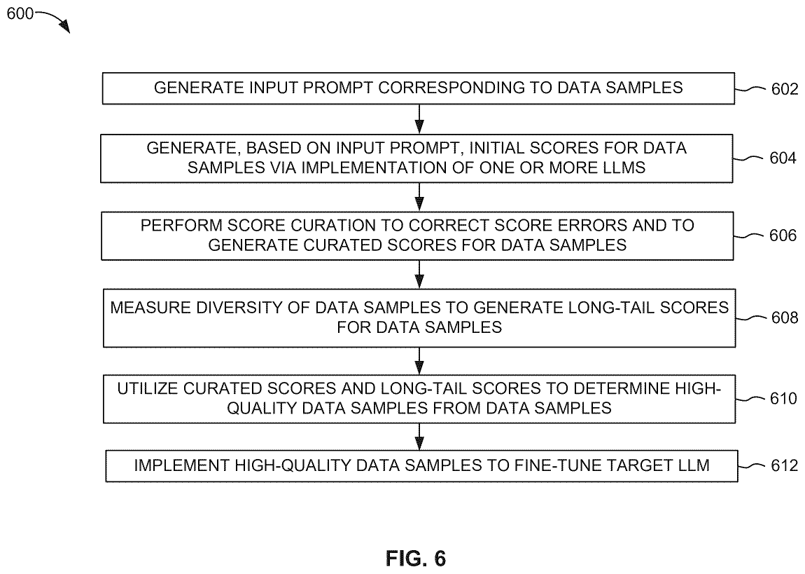

FIG. 6 is a flow diagram that presents a method 600 for curating the high-quality data samples 250A to enhance LLM performance, in accordance with implementations of the present disclosure. In some implementations, the method 600 may be executed by the processor 112 (including the one or more processors described herein) using the data curator and trainer 116, as described in relation to FIGS. 1-3.

At step 602, the method 600 includes generating the input prompt corresponding to the data samples 250 of one or more datasets related to the enterprise.

Based on the input prompt, at step 604, the method 600 includes generating the initial scores 252 for the data samples 250 via implementation of one or more of the LLMs 110. In some examples, for generating the initial scores 252 may include rating the data samples 250 according to a pre-determined scale and based on one or more of relevance, complexity, and clarity. By way of non-limiting example, the pre-determined scale may vary in a range of ‘0’ to ‘5’. Further, the method 600 may use the initial scores 252 to determine the high-rated data samples among the data samples. Generating the initial scores 252 is described in detail in FIG. 2, along with the initial score generator 204 of the data curator and trainer 116.

At step 606, the method 600 includes performing score curation to correct score errors and to generate the curated scores 254 for the data samples 250. In some examples, for performing the score curation, the method 600 may include implementing the K-NN clustering to determine the score transition matrix, utilizing the score transition matrix to determine the error threshold, and utilizing the error threshold to filter out the mis-rated data samples. Generating the curated scores is described in detail in FIG. 2 along with the curated score generator 206 of the data curator and trainer 116.

At step 608, the method 600 includes measuring diversity of the data samples 250 to generate the long-tail scores 256 for the data samples 250. In some examples, for measuring the diversity of the data samples 250 may include generating the embeddings for the data samples 250, implementing the K-NN clustering to measure embedding distances for the data samples 250, and applying a cosine similarity metric to the embedding distances. The embeddings may include a numerical representation of the corresponding data samples 250.

At step 610, the method 600 includes utilizing the curated scores 254 and the long-tail scores 256 to determine the high-quality data samples 250A from the data samples 250.

At step 612, the method 600 includes implementing the high-quality data samples to fine-tune the target LLM 110A. Fine-tuning of the target LLM 110A may include training the target LLM 110A using the high-quality data samples 250A and updating, based on the training, at least one aspect of the target LLM 110A.

Implementations of the present disclosure provide technical solutions to multiple technical problems that arise in the context of data selection processes performed enhancing LLM performance. Implementations of the present disclosure provide a diversity-aware score curation framework, which may employ an efficient data selection pipeline that enhances the quality and performance of the target LLM 110A and improves alignment of the target LLM 110A with user values or expectations. The diversity-aware score curation framework may enhance the quality of the target LLM 110A by incorporating score curation and noise reduction techniques. In addition, the diversity-aware score curation framework may account for rarity of the data samples 250 to ensure both accuracy and richness of selected data samples. Therefore, the diversity-aware score curation framework may improve the reliability of LLM alignment, reduce the requirement for costly expert-driven models, and achieve more efficient and scalable deployment of the LLMs 110.

The score curation performed by the proposed diversity-aware score curation framework may systematically identify and correct score errors in the initial scores 252 of the data samples 250 generated via implementation of one or more of the LLMs, thereby ensuring higher accuracy and reliability. To ensure the selected data samples are diverse and representative, the diversity-aware score curation framework may use a diversity-aware scoring system. The diversity-aware scoring system may measure how different each data sample is from others, ensuring that the dataset includes a wide range of examples. Such a combination of high quality and diverse data improves the LLM performance in various applications. Further, the proposed diversity-aware score curation framework may reduce inaccuracies and biases by systematically correcting the score errors, lower costs by reducing reliance on expensive models and ensure data diversity, which further enhances the robustness and generalization of the LLMs. Additionally, the proposed diversity-aware score curation framework may reduce the need for costly and time-consuming human annotations.

Furthermore, the proposed diversity-aware score curation framework may increase processing speed by automating the rating/scoring process of the data samples. In addition, the proposed diversity-aware score curation framework may reduce storage requirements by refining the data selection process, resulting in selection of small and high-quality data samples for fine-tuning of the target LLM. The high-quality data samples may include high-quality and diverse data samples, which optimizes utilization of computational resources during fine-tuning of the target LLM that may further lead to improved performance of the target LLM with potentially less computational effort. The diversity-aware score curation framework provided herein may further enable efficient unlearning capabilities in the LLMs, which enhances privacy, reduces bias, and ensures compliance with regulations.

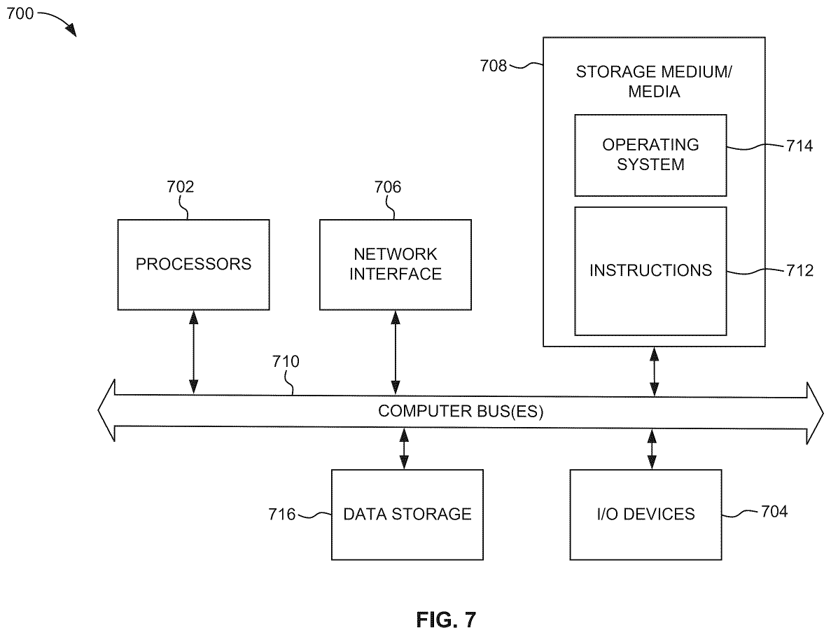

FIG. 7 depicts a computer system 700 that may be used to implement the system 102. More particularly, computing machines such as desktops, laptops, smartphones, tablets, and wearables which may be used to curate high-quality data samples for enhancing LLM performance. The computer system 700 may include additional components not shown and that some of the process components described may be removed and/or modified. In another example, a computer system 700 may be deployed on external-cloud platforms such as cloud, internal corporate cloud computing clusters, organizational computing resources, and/or the like.

The computer system 700 includes processor(s) 702, such as a central processing unit, ASIC or another type of processing circuit, input/output devices 704, such as a display, mouse keyboard, etc., a network interface 706, such as a Local Area Network (LAN), a wireless 802.11x LAN, a 3G or 4G mobile WAN or a WiMAX WAN, and a computer-readable medium 708. Each of these components may be operatively coupled to a bus 710. The computer-readable medium 708 may be any suitable medium that participates in providing instructions to the processor(s) 702 for execution. For example, the computer-readable medium 708 may be non-transitory or non-volatile medium, such as a magnetic disk or solid-state non-volatile memory or volatile medium such as RAM. The instructions or modules stored on the computer-readable medium 708 may include machine-readable instructions 712 executed by the processor(s) 702 that cause the processor(s) 702 to perform the methods and functions of the system 102.

The system 102 may be implemented as software stored on a non-transitory processor-readable medium and executed by the processor(s) 702. For example, the computer-readable medium 708 may store an operating system 714, such as MAC OS, MS WINDOWS, UNIX, or LINUX, and code, for the system 102. The operating system 714 may be multi-user, multiprocessing, multitasking, multithreading, real-time, and the like. For example, during runtime, the operating system 714 is running and the code for the system 102 is executed by the processor(s) 702.

The computer system 700 may include a data storage 716, which may include non-volatile data storage. The data storage 716 stores any data used or generated by the system 102.

The network interface 706 connects the computer system 700 to internal systems for example, via a LAN. Also, the network interface 706 may connect the computer system 700 to the Internet. For example, the computer system 700 may connect to web browsers and other external applications and systems via the network interface 706.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 702 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method for curating high-quality data samples to enhance Large Language Model (LLM) performance, the method comprising:
generating an input prompt corresponding to data samples of one or more datasets related to an enterprise;
generating, based on the input prompt, initial scores for the data samples via implementation of one or more LLMs;
performing score curation to correct score errors and to generate curated scores for the data samples;
measuring diversity of the data samples to generate long-tail scores for the data samples;
utilizing the curated scores and the long-tail scores to determine the high-quality data samples from the data samples; and
implementing the high-quality data samples to fine-tune a target LLM, including training the target LLM using the high-quality data samples and updating, based on the training, at least one aspect of the target LLM.

2. The method according to claim 1, wherein generating the initial scores includes rating the data samples according to a pre-determined scale.

3. The method according to claim 2, where generating initial scores includes rating the data samples based one or more of relevance, complexity, and clarity.

4. The method according to claim 3, wherein generating the initial scores includes determining high-rated data samples among the data samples.

5. The method according to claim 1, wherein performing the score curation includes implementing K-Nearest Neighbor (K-NN) clustering to determine a score transition matrix.

6. The method according to claim 5, wherein performing the score curation includes utilizing the score transition matrix to determine an error threshold.

7. The method according to claim 6, wherein performing score curation includes utilizing the error threshold to filter out mis-rated data samples.

8. A non-transitory computer-readable storage medium having an executable stored thereon, which when executed instructs a processor to:
generate an input prompt corresponding to data samples of one or more datasets related to an enterprise;
generate, based on the input prompt, initial scores for the data samples via implementation of one or more Large Language Models (LLMs);
perform score curation to correct score errors and to generate curated scores for the data samples;
measure diversity of the data samples to generate long-tail scores for the data samples;
utilize the curated scores and the long-tail scores to determine high-quality data samples from the data samples; and
implement the high-quality data samples to fine-tune a target LLM.

9. The non-transitory computer-readable storage medium of claim 8, wherein to generate initial scores, the executable when executed further instructs the processor to rate the data samples according to a pre-determined scale.

10. The non-transitory computer-readable storage medium of claim 9, wherein to generate initial scores, the executable when executed further instructs the processor to rate the data samples based one or more of relevance, complexity, and clarity.

11. The non-transitory computer-readable storage medium of claim 10, wherein to generate initial scores, the executable when executed further instructs the processor to determine high-rated data samples among the data samples.

12. The non-transitory computer-readable storage medium of claim 8, wherein to perform score curation, the executable when executed further instructs the processor to implement K-Nearest Neighbor (K-NN) clustering to determine a score transition matrix.

13. The non-transitory computer-readable storage medium of claim 12, wherein to perform score curation, the executable when executed further instructs the processor to utilize the score transition matrix to determine an error threshold.

14. The non-transitory computer-readable storage medium of claim 8, wherein to measuring diversity of the data samples, the executable when executed further instructs the processor to:
generate embeddings for the data samples, wherein the embeddings comprise a numerical representation of the data samples; and
implement the K-NN clustering to measure embedding distances for the data samples.

15. The non-transitory computer-readable storage medium of claim 14, wherein to measuring diversity of the data samples, the executable when executed further instructs the processor to apply a cosine similarity metric to the embedding distances.

16. A system comprising:
a processor; and
a memory communicably coupled to the processor, wherein the memory comprises processor-executable instructions which, when executed by the processor, cause the processor to:
generate an input prompt corresponding to data samples of one or more datasets related to an enterprise;
generate, based on the input prompt, initial scores for the data samples via implementation of one or more Large Language Models (LLMs);
perform score curation to correct score errors and to generate curated scores for the data samples;
measure diversity of the data samples to generate long-tail scores for the data samples;
utilize the curated scores and the long-tail scores to determine high-quality data samples from the data samples; and
implement the high-quality data samples to fine-tune a target LLM.

17. The system of claim 16, wherein to perform the score curation, the processor is to utilize a score transition matrix to determine an error threshold.

18. The system of claim 17, wherein to perform the score curation, the processor is to utilize the error threshold to filter out mis-rated data samples.

19. The system of claim 16, wherein to measure the diversity of the data samples, the processor is to implement K-Nearest Neighbor (K-NN) clustering to measure embedding distances for the data samples.

20. The system of claim 19, wherein to measure the diversity of the data samples, the processor is to apply a cosine similarity metric to the embedding distances to calculate the long-tail scores for the data samples.
